(19) United States
(12) Patent Application Publication
(10) Pub. No.: US 2015/0204108 A1
(43) Pub. Date: Jul. 23, 2015

(54) Key Fob Having Electrical Port Concealed by Removable Key

(71) Applicant: Lear Corporation, Southfield, MI (US)

(72) Inventors: Riad Ghabra, Northville, MI (US); William Ramsey Reynolds, Beverly Hills, MI (US)

(21) Appl. No.: 14/330,099

(22) Filed: Jul. 14, 2014

(51) Int. Cl. E05B 19/00

(52) U.S. Cl. CPC E05B 19/0082

(57) ABSTRACT

A key fob assembly includes a key fob and a removable key. The key fob has an electrical port. The removable key is storable in the key fob. The removable key conceals the electrical port when the removable key is stored in the key fob. The electrical port is exposed when the removable key is removed from the key fob.

### TECHNICAL FIELD

The present invention relates to a key fob having a removable key.

### BACKGROUND

An electronic key fob (“fob”) is a portable remote control for controlling functions. As an example, a function to be controlled involves unlocking a locked door. Some fobs include a removable key. The removable key is a conventional mechanical key stored within the fob. A user may remove the removable key from the fob to use the removable key in the manner of a conventional mechanical key such as, for example, to unlock the locked door.

### SUMMARY

An embodiment of the present invention includes a key fob assembly having a key fob (“fob”) and a removable key. The fob has an electrical port. The removable key is storable in the fob. The removable key conceals the electrical port when the removable key is stored in the fob. The electrical port is exposed when the removable key is removed from the fob.

The fob may include a housing having a key shank slot and an end face. The electrical port is on the end face of the housing and the key shank slot has an opening in the end face of the housing. The removable key may include a key handle which covers the end face of the housing including the electrical port and the opening of the key shank slot when the removable key is stored in the fob. The removable key may further include a key shank which resides within the key shank slot when the removable key is stored in the fob.

The fob may further include a rechargeable battery electrically connected to the electrical port. The rechargeable battery is rechargeable by a battery charger connected to the electrical port when the electrical port is exposed.

The fob may further include data communications circuitry electrically connected to the electrical port. The data communications circuitry and an external data communications device connected to the electrical port communicate data with one another via the electrical port when the electrical port is exposed.

The electrical port may be a universal serial bus (USB) port or a micro-USB port.

Another embodiment of the present invention includes a remote control system for a vehicle. The system includes a fob and a removable key. The fob is configured to remotely control at least one function of a vehicle, the fob having an electrical port. The removable key is storable in the fob. The removable key is configured to operate at least one of a door and an ignition of the vehicle. The removable key conceals the electrical port when the removable key is stored in the fob. The electrical port is exposed when the removable key is removed from the fob.

### BRIEF DESCRIPTION OF THE DRAWINGS

FIG. 1 illustrates a perspective view of a key fob assembly having a key fob (“fob”) and a removable key in accordance with an embodiment of the present invention in which the removable key is removed from the fob and thereby exposes an electrical port of the fob;

FIG. 2 illustrates a perspective view of the key fob assembly in which the removable key is stored within the fob and thereby conceals the electrical port of the fob;

FIG. 3 illustrates a block diagram of the fob;

FIG. 4 illustrates a schematic view of an external battery charger connected to the electrical port of the fob for the battery charger to charge a rechargeable battery of the fob; and

FIG. 5 illustrates a schematic view of a data communications device such as a computer connected to the electrical port of the fob for the computer and the fob to communicate data with one another.

### DETAILED DESCRIPTION

Detailed embodiments of the present invention are disclosed herein; however, it is to be understood that the disclosed embodiments are merely exemplary of the present invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

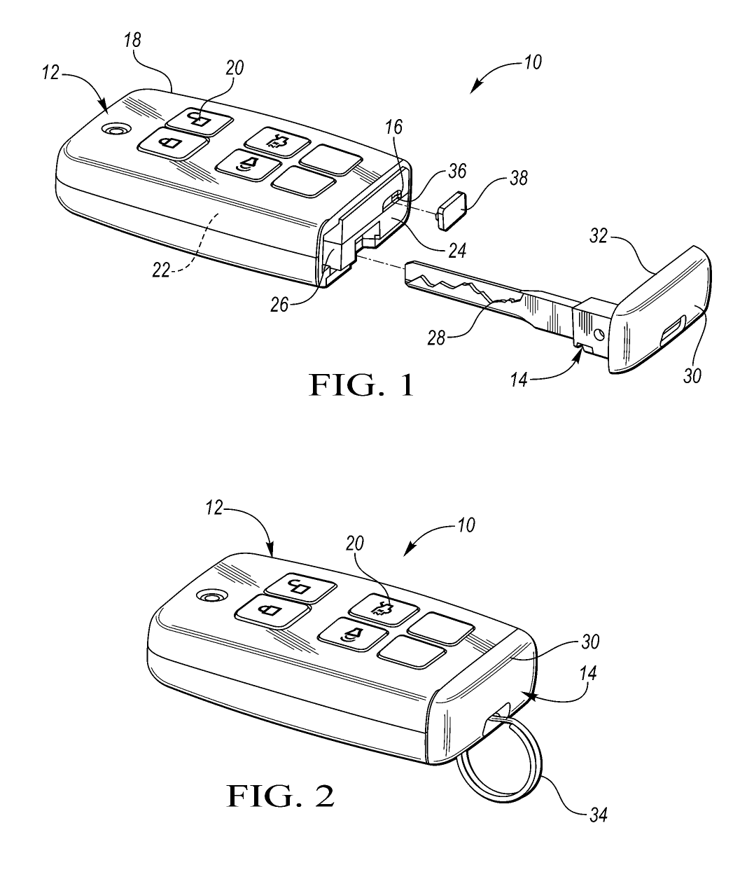

Referring now to FIGS. 1 and 2, a key fob assembly 10 in accordance with an embodiment of the present invention will be described. Key fob assembly 10 includes an electronic key fob (“fob”) 12 and a removable key 14. In FIG. 1, removable key 14 is removed from fob 12. In FIG. 2, removable key 14 is stored within fob 12.

As an example, key fob assembly 10 is part of a remote control system for a vehicle. Vehicle remote control systems include remote keyless entry (RKE) and passive entry passive start (PEPS) systems. As part of an RKE system, fob 12 may control a vehicle function in response to user actuation of buttons or the like of the fob. As part of a PEPS system, fob 12 may control a vehicle function automatically (or “passively”) without user actuation of the fob. Vehicle functions which may be controlled by RKE and/or PEPS systems include locking and unlocking vehicle doors, opening the vehicle truck, sounding a vehicle alarm or horn, and vehicle immobilizer, keyless engine start, remote start, etc. In other examples, key fob assembly 10 is part of a remote control system for a house, garage, gate, or building, etc.

In the depicted embodiment of FIGS. 1 and 2, fob 12 is configured to perform RKE vehicle control functions. (Of course, fob 12 may also be configured to perform PEPS vehicle control functions in addition to being configured to perform RKE vehicle control functions.) Fob 12 includes one or more buttons 20 in order to perform the RKE vehicle control functions. A user may actuate a button(s) 20 to cause fob 12 to initiate a corresponding RKE vehicle control function. Buttons 20 are exposed on a front face of a housing 18 of fob 12 to be accessible for user actuation.

Housing 18 of fob 12 forms an enclosure which houses electrical components of the fob. The front face of housing 18 includes openings for accommodating buttons 20. The openings are generally the same size and shape as the corresponding buttons 20 so that a sealed junction is formed therebetween. For instance, housing 18 is a plastic molded component. Housing 18 further forms a key shank slot 22. Key shank slot 22 is generally defined within and extends the length of housing 18. Key shank slot 22 is configured to receive a key shank 28 of removable key 14. Housing 18 includes an end face 24. Key shank slot 22 is accessible at an opening 26 in end face 24 of housing 18.

Removable key 14 includes key shank 28 and a key handle 30. Removable key 14 is thereby similar to a conventional mechanical key. Removable key 14 may be inserted into and removed from fob 12. Removable key 14 inserts into fob 12 by a user pressing key handle 30 to insert key shank 28 into key shank slot 22. Key shank 28 passes through opening 26 in end face 24 of housing 18 to insert into key shank slot 22. Key shank 28 resides within key shank slot 22 with an inner surface 32 of key handle 30 meeting end face 24 of housing 18 when removable key 14 is inserted into fob 12 (shown in FIG. 2). As shown in FIG. 2, key handle 30 conforms to the overall contour or shape of housing 18 when removable key 14 is inserted into fob 12. Key handle 30 may include a mechanical key ring 34 attached thereto for holding conventional mechanical keys.

Removable key 14 is removed from fob 12 by a user pulling on key handle 30 to pull key shank 28 out from key shank slot 22. As a result, removable key 14 is separated from fob 12 (shown in FIG. 1) and may be used in the manner of a conventional mechanical key. After use of removable key 14, the user may insert the removable key back into fob 12 for storage therein. To help retain removable key 14 in fob 12, suitable detents may be provided in housing 18 of fob 12 for snapping removable key 14 thereto. Key shank slot 22 may also be lined with a material such as rubber in order to provide high-friction interference fit when key shank 28 is inserted in key shank slot 22.

As shown in FIG. 1, fob 12 further includes an electrical port 16. Electrical port 16 is accommodated within a corresponding opening 36 in end face 24 of housing 18. Electrical port 16 is thereby accessible to the external environment when removable key 14 is removed from fob 12. In particular, as shown in FIG. 2, key handle 30 covers end face 24 of housing 18 including electrical port 16 when removable key 14 is inserted into key shank slot 22. Removing removable key 14 from fob 12, as shown in FIG. 1, exposes electrical port 16. When exposed, electrical port 16 may be physically and electrically connected to a wired connection to provide wired connectivity between fob 12 and one or more external electronic devices.

Electrical port 16 may have an associated rubber stop member 38 or the like. Rubber stop member 38 may be inserted into electrical port 16 to prevent contamination ingress while wired connectivity is not established with the electrical port. As such, rubber stop member 38 may be inserted into electrical port 16 even while removable key 14 is stored within fob 12 as shown in FIG. 2. In the stored arrangement of removable key 14 as shown in FIG. 2, rubber stop member 38 inserted into electrical port 16 further meets inner surface 32 of key handle 30 of removable key 14. Without rubber stop member 38 being present electrical port 16 directly meets inner surface 32 of key handle 30 of removable key 14 in the stored arrangement of removable key 14. Rubber stop member 38 may be affixed by adhesive or otherwise to the inner surface 32 of key handle 30 such that rubber stop member 38 is inserted and removed into electrical port 16 along with insertion and removal of removable key 14 from fob 12.

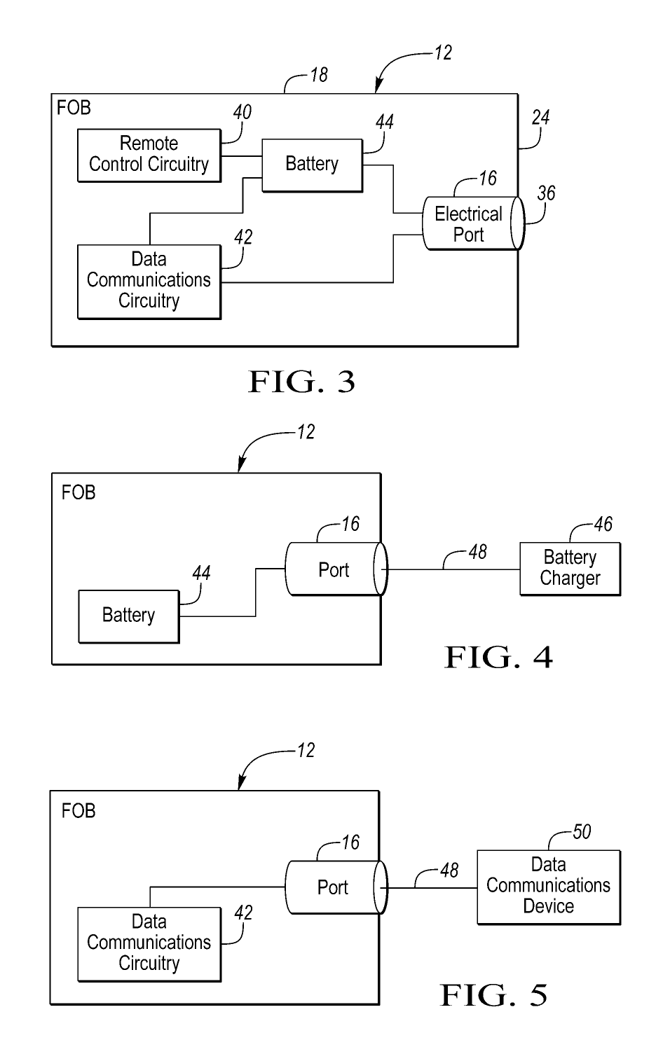

Referring now to FIG. 3, with continual reference to FIG. 1, a block diagram of fob 12 is shown. Fob 12 includes remote control circuitry 40 for handling the remote control functions of the fob. For instance, remote control circuitry 40 includes a transmitter for wirelessly transmitting remote control command signals. Fob 12 may further include data communications circuitry 42 for communicating data between fob 12 and external data communications devices such as a computer.

Fob 12 further includes a power source for providing the electrical components of the fob such as remote control circuitry 40 and data communications circuitry 42 with electrical power to enable operation of the fob. In one embodiment, the power source includes a rechargeable battery 44 housed internally within housing 18. Alternatively, rechargeable battery 44 is a replaceable battery provided within its own compartment on the rear side of housing 18. The user may remove removable key 14 from fob 12 when the fob is inoperable due to rechargeable battery 44 having insufficient battery energy.

As shown in FIG. 3, electrical port 16 of fob 12 is connected to data communications circuitry 42 (if present) and rechargeable battery 44. As such, electrical port 16 is an intermediary between (i) data communications circuitry 42 and rechargeable battery 44 and (ii) the external environment. As indicated above, when electrical port 16 is exposed such as when removable key 14 is removed from fob 12, the electrical port may be physically and electrically connected to a wired connection to provide wired connectivity between the fob and an external electronic device. The external electronic device and rechargeable battery 44 (and data communications circuitry 42 if present) are thereby connected to one another via the wired connection and electrical port 16.

In the depicted embodiment shown in FIG. 1, electrical port 16 is a universal serial bus (USB) port. In particular, electrical port 16 is a microUSB port. However, electrical port 16 may be any standard electronic interface, a FireWire connection, a PC card slot. In general, electrical port 16 may be any known type of suitable port, interface, jack, receptacle, slot, etc. As can be appreciated, precautions are desired to keep water, dirt, and other debris away from electrical port 16 when not in use. Providing electrical port 16 on end face 24 of housing 18 enables such protection as key handle 30 of removable key 14 completely conceals and protects the electrical port when the removable key is stored in fob 12 as shown in FIG. 2.

Referring now to FIG. 4, with continual reference to FIGS. 1 and 3, a schematic view of an external battery 46 such as a connected to electrical port 16 of fob 12 is shown. External battery 46 is connected to electrical port 16 of fob 12 for the external battery to charge rechargeable battery 44 of the fob. Again, while exposed as a result of removable key 14 being removed from fob 12 as shown in FIG. 1, electrical port 16 may be physically and electrically connected to a wired connection 48 connected to external battery 46 to provide wired connectivity between fob 12 and the external battery as shown in FIG. 4.

Referring now to FIG. 5, with continual reference to FIGS. 1 and 3, a schematic view of a data communications device such as a computer 50 connected to electrical port 16 of the fob is shown. Computer 50 is connected to electrical port 16 for the computer and fob 12 to communicate data with one another. Again, while exposed, electrical port 16 may be physically and electrically connected to wired connection 48 (or a different wired connection) connected to computer 50 to provide wired connectivity between fob 12 and the computer as shown in as shown in FIG. 5. For instance, that wired connection may be used to program fob 12 to operate two or more different vehicles or to perform various optional functions.

As described, an embodiment of a key fob assembly includes a fob having a concealed (charging and/or data) electrical port. For instance, the electrical port is a microUSB port. The port is concealed by a removable key of the key fob assembly. A key handle of the removable key conceals the port when the removable key is stored in the fob. That is, the entire electrical port is hidden behind the key handle of the removable key. As a result, the electrical port is concealed in a manner such that it is not visible to a user and such that it is not easily damaged by impact and is sealed against water ingress in a way that is hidden away. When the fob is ready for charging, for example, a user removes emergency key from the fob to thereby expose the electrical port and then plugs a battery charger to the electrical port.

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed is:

1. A key fob assembly comprising:
a fob having an electrical port; and
a removable key storable in the fob, wherein the removable key conceals the electrical port when the removable key is stored in the fob, wherein the electrical port is exposed when the removable key is removed from the fob.

2. The assembly of claim 1 wherein:
the fob further includes a housing having a key shank slot and an end face, wherein the electrical port is on the end face of the housing and the key shank slot has an opening in the end face of the housing.

3. The assembly of claim 2 wherein:
the removable key includes a key handle, wherein the key handle covers the end face of the housing including the electrical port and the opening of the key shank slot when the removable key is stored in the fob.

4. The assembly of claim 3 wherein:
the removable key further includes a key shank, wherein the key shank resides within the key shank slot when the removable key is stored in the fob.

5. The assembly of claim 1 wherein:
the electrical port is configured to be connected to a wired connection to provide wired connectivity between the fob and an external electronic device when the electrical port is exposed.

6. The assembly of claim 1 wherein:
the fob further includes a rechargeable battery electrically connected to the electrical port, wherein the rechargeable battery is rechargeable by a battery charger connected to the electrical port when the electrical port is exposed.

7. The assembly of claim 1 wherein:
the fob further includes a housing having a key shank slot and an end face, wherein the electrical port is on the end face of the housing and the key shank slot has an opening in the end face of the housing;
the fob further including a rechargeable battery housed within the housing and electrically connected to the electrical port, wherein the rechargeable battery is rechargeable by a battery charger connected to the electrical port when the electrical port is exposed.

8. The assembly of claim 1 wherein:
the fob further includes data communications circuitry electrically connected to the electrical port, wherein the data communications circuitry and an external data communications device connected to the electrical port when the electrical port is exposed communicate data with one another.

9. The assembly of claim 1 wherein
the electrical port is a universal serial bus (USB) port.

10. The assembly of claim 1 wherein:
the electrical port is a micro-universal serial bus (USB) port.

11. The assembly of claim 1 wherein:
the fob is configured to remotely control a vehicle function.

12. A remote control system for a vehicle, the system comprising:
a fob configured to remotely control at least one function of a vehicle, the fob having an electrical port; and
a removable key storable in the fob, the removable key configured to operate at least one of a door and an ignition of the vehicle, wherein the removable key conceals the electrical port when the removable key is stored in the fob, wherein the electrical port is exposed when the removable key is removed from the fob.

13. The system of claim 12 wherein:
the fob further includes a housing having a key shank slot and an end face, wherein the electrical port is on the end face of the housing and the key shank slot has an opening in the end face of the housing.

14. The system of claim 13 wherein:
the removable key includes a key handle, wherein the key handle covers the end face of the housing including the electrical port and the opening of the key shank slot when the removable key is stored in the fob.

15. The system of claim 14 wherein:
the removable key further includes a key shank, wherein the key shank resides within the key shank slot when the removable key is stored in the fob.

16. The system of claim 12 wherein:
the fob includes a rechargeable battery electrically connected to the electrical port, wherein the rechargeable battery is rechargeable by a battery charger connected to the electrical port when the electrical port is exposed.

17. The system of claim 12 wherein:
the fob further includes data communications circuitry electrically connected to the electrical port, wherein the data communications circuitry and an external data communications device connected to the electrical port when the electrical port is exposed communicate data with one another.

18. The system of claim 12 wherein
the electrical port is a universal serial bus (USB) port.

19. The system of claim 12 wherein:
the electrical port is a micro-universal serial bus (USB) port.
